(19) United States
(12) Patent Application Publication
(10) Pub. No.: US 2015/0051754 A1
(43) Pub. Date: Feb. 19, 2015

(54) CONTROL DEVICE AND CONTROL METHOD FOR CONTROLLING FUNCTION OF VEHICLE

(71) Applicants: Hyundai Motor Company, Seoul (KR); Hyundai Autoever Corp., Seoul (KR); Kia Motors Corporation, Seoul (KR)

(72) Inventors: Sun Woo Kwon, Seoul (KR); Tae Won Kim, Seoul (KR); Seung Uk Yun, Seoul (KR)

(73) Assignees: Hyundai Motor Company, Seoul (KR); Hyundai Autoever Corp., Seoul (KR); Kia Motors Corporation, Seoul (KR)

(21) Appl. No.: 14/142,169

(22) Filed: Dec. 27, 2013

(30) Foreign Application Priority Data
Aug. 19, 2013 (KR) 10-2013-0097897

(51) Int. Cl. B60R 16/023

(52) U.S. Cl. CPC B60R 16/0231
USPC 701/2; 701/1

(57) ABSTRACT

A control device that communicates with a vehicle function controller to execute functions associated with a vehicle is provided. In particular, conditions for executing functions to be automatically executed among the functions associated with the vehicle are set based on user intention and the functions to be automatically executed are set based on the user intention when the set conditions are satisfied. Thus, the functions of the vehicle, or the like, are automatically executed based on the conditions to optimize the functions of the vehicle, or the like, for individual users.

### CROSS-REFERENCE TO RELATED APPLICATION

This application is based on and claims priority from Korean Patent Application No. 10-2013-0097897, filed on Aug. 19, 2013 in the Korean Intellectual Property Office, the disclosure of which is incorporated herein in its entirety by reference.

### BACKGROUND

1. Field of the Invention

The present invention relates to a control device and a control method for operating a function of a vehicle.

2. Description of the Prior Art

Recently, vehicles have provided various convenient functions to users and the vehicle has been used for additional functions besides as a transport unit. In accordance with rapid popularization of terminals connected to wireless Internet and 3G/4G data networks, an attempt to conduct the connection between the terminal and a vehicle has increased. That is, an information technology (IT) has been developed toward a technology of enabling the vehicle to serve as the object or the subject on the network.

Meanwhile, a vehicle or a peripheral device of the vehicle (hereinafter, referred to as a ‘vehicle, or the like’) having various automatic control functions provided by a manufacturer of the vehicle or the peripheral device of the vehicle has been known. However, users cannot automatically control these predetermined automatic control functions, and different functions required by each user has not been provided to each user in a one-stop scheme.

### SUMMARY

Accordingly, the present invention provides a control device and a control method that may increase a degree of freedom by allowing users to set automatic execution preconditions for automatically executing functions of the vehicle based on user intentions and allowing users to individually set automatically executed functions. Further, information required to determine the automatic execution preconditions may be based on information obtained from a mobile communication terminal and a network, and the automatically executed functions are not limited to being applied to a control for the vehicle, but may also be applied to a control for other devices present within the vehicle.

In one aspect of the present invention, a control device that communicates with a vehicle function controller that executes functions associated with a vehicle and requests the vehicle function controller to execute the functions, may include: a condition setting unit configured to set conditions for executing functions to be automatically executed among the functions associated with the vehicle based on user intention; and an execution setting unit configured to set the functions to be automatically executed based on the user intention when the set conditions are satisfied. The execution setting unit may be configured to categorize the functions to be automatically executed into a plurality of categories, and the user may select the categories.

The control device may further include an information receiving unit configured to receive information from the vehicle, information from the control device, or information from a network and provide the received information to the condition setting unit. The condition setting unit may be configured to categorize information received by the information receiving unit into a plurality of categories, and the user may select the categories. The functions to be automatically executed may operate at least any one of the vehicle, a device within the vehicle, and a device connected to a network. The set conditions or the functions to be automatically executed may be changed after being set. The control device may be included in the vehicle function controller. The control device may be included within a portable terminal.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary block diagram showing a control device according to an exemplary embodiment of the present invention;

FIG. 2 is an exemplary schematic view of Exemplary Embodiment 1 in which the control device is mounted within a mobile communication terminal and a vehicle function controller is mounted within a vehicle according to an exemplary embodiment of the present invention;

FIG. 3 is an exemplary view showing a screen displayed on a display unit while conditions are being set according to an exemplary embodiment of the present invention;

FIGS. 4A to 4H are exemplary views showing a screen for selecting details of conditions according to an exemplary embodiment of the present invention;

FIG. 5 is an exemplary view showing a screen displayed on a display unit while automatic execution contents are set;

FIGS. 6A to 6E are exemplary views a screen for selecting details of execution contents according to an exemplary embodiment of the present invention;

FIG. 7 is an exemplary schematic view of Exemplary Embodiment 2 in which the control device is mounted within a vehicle function controller of a vehicle according to an exemplary embodiment of the present invention;

FIG. 8 is an exemplary flow chart showing an operating process of the control device according to the exemplary embodiment of the present invention;

FIG. 9 is an exemplary flow chart showing processes corresponding to S103 and S104 of FIG. 8 in detail according to an exemplary embodiment of the present invention; and

FIG. 10 is an exemplary schematic view showing an operation of the control device according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived firm resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, a control device and a control method of requesting a vehicle function controller to execute vehicle functions to an exemplary embodiment of the present invention will be described with reference to the accompanying drawings. In addition, the present invention is not limited to the following exemplary embodiments.

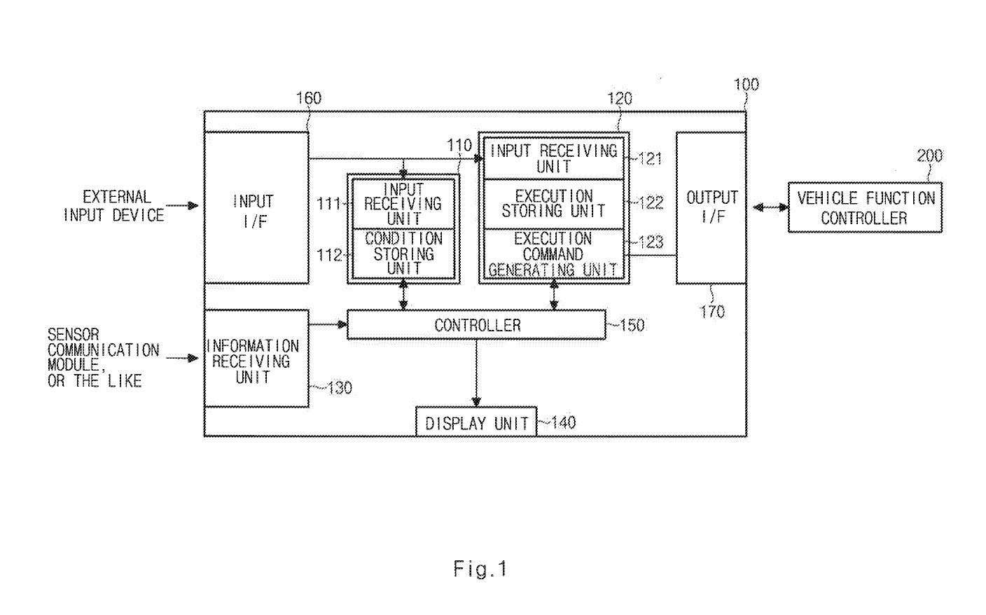

FIG. 1 is an exemplary block diagram showing a control device according to an exemplary embodiment of the present invention. The control device 100 may include a plurality of units executed by a controller 150. The plurality of units may include a condition setting unit 110, an execution setting unit 120, an information receiving unit 130, a display unit 140, an input interface (I/F) 160, and an output interface (I/F) 170. Although not shown, the respective components in the control device 100 may be electrically connected appropriately to each other. In addition, in the present invention, the control device 100 may not include only the respective components that are shown, but may further include appropriate components such as a power supplying unit, and the like, that are not shown.

The condition setting unit 110 may be a component configured to set a precondition (hereinafter, referred to as a ‘condition’) under which the execution setting unit 120 may be configured to generate a command signal (e.g., an execution command) to execute a specific function. More specifically, the condition setting unit may include an input receiving unit 111 and a condition storing unit 112. The input receiving unit 111 may be configured to receive an operating signal for a condition from the input I/F 160 included in the control device 100 and may be configured to store the operating signal in the condition storing unit 112.

Meanwhile, the condition stored in the condition storing unit 112 may be referenced by the controller 150 as described below and may correspond to an execution content to generate an execution command (hereinafter, referred to as an ‘execution content’ or an ‘automatic execution content’). The execution setting unit 120 may be configured to generate the execution command when the set condition is satisfied and transmit the generated execution command to a vehicle function controller 200. More specifically, the execution setting unit 120 may include an input receiving unit 121, an execution storing unit 122, and an execution command generating unit 123. To set an automatic execution content, the execution setting unit 120 may be configured to receive the operating signal to set the automatic execution content transmitted from the input I/F 160 at the input receiving unit 121 and store the received operating signal in the execution storing unit 122. Thus, the execution setting unit 120 may be configured to set and store the automatic execution content that corresponds to the above-mentioned condition.

Furthermore, the controller 150 may be configured to reference the condition stored in the condition storing unit 112 and information received from the information receiving unit 130 and match the conditions. As the matching result, when the information received from the information receiving unit 130 and the stored condition correspond, the execution command generating unit 123 of the execution setting unit 120 may be configured to generate the set automatic execution content stored in the execution storing unit 122 as the execution command. The execution command generated as described above may be transmitted to the vehicle function controller 200 via the output I/F 170.

The input I/F 160 may be configured to receive an operating signal for an input transmitted from an external input device (not shown). The external input device may include, for example, a device that transmits input information via a network and a general input device such as a text input device such as a keyboard, a touch panel in which the keyboard is shaped, or the like, a pointing input device, an audio input device that converts an audio signal input via a microphone, or the like, into an electrical signal. Further, the external input device may be integrated with the control device 100, particularly, the display unit 140 of the control device 100. For example, the external input device may be a touch panel (or a position detecting device) provided in the display unit 140.

The operating signal received from the input I/F 160 may be transmitted to the input receiving unit 111 of the condition setting unit 110 and/or the input receiving unit 121 of the execution setting unit 120 as described above. The output I/F 170 may be configured to receive the execution command generated and transmitted by the execution command generating unit 123 as described above and transmit the execution command to the vehicle function controller 200. In particular, as a method of transmitting the execution command to the vehicle function controller 200 via the output I/F, for example, a wired electrical connection or a wireless data carrier via WiFi, 3G/4G data networks, a near field communication network, or the like, may be used.

The information receiving unit 130 may be configured to receive information recognized by sensors and recognizing devices that may be mounted within the vehicle, including various sensors, modules, and the like, of the vehicle, such as a temperature sensor, an illuminance sensor, a lane departure preventing sensor, front and rear imaging devices, a fuel sensing sensor, a global positioning system (GPS) module (sensor), and the like. In addition, the information receiving unit 130 may be configured to receive information recognized by sensors and modules that may be mounted within a mobile communication terminal, such as a gyroscope sensor, a geomagnetic sensor, an acceleration sensor, an optical (illuminance) sensor, a proximity sensor, a digital compass, a communication module, a GPS module, a near field communication module, a temperature sensor. Further, the information receiving unit 130 may also be configured to receive information, or the like, obtained from a terminal within the vehicle or a mobile communication terminal via the Internet or a network that may be connected to a public application programming interface (API), or the like. The information received as described above may be utilized to determine whether the set condition is satisfied.

In addition, the information, for example, weather information, temperature information, map information, traffic information, other information, and the like, obtained from the network may also be implemented in a so-called ‘mash-up form’ with other applications (or programs).

The display unit 140 may be executed by the controller 150 to display operations of all components of the control device 100 according to the exemplary embodiment of the present invention including a condition setting unit 110 and an execution setting unit 120 in a graph screen form to be visually recognized by users. The display unit 140 may be, for example, a display of a smart phone, a display of a vehicle terminal, or the like. However, the display unit 140 is not limited thereto, but may also be provided separately from a device (the mobile communication terminal, or the vehicle terminal, or the like) in which the control device 100 is installed.

The controller 150 may be configured to operate the respective components of the control device 100 according to the exemplary embodiment of the present invention. In particular, the controller 150 may be configured to reference the set condition stored in the condition storing unit 112 of the condition setting unit 110 and the information received from the information receiving unit 130 and match the conditions. Then, when the information received from the information receiving unit 130 and the stored condition correspond (e.g., match), the controller 150 may be configured to transmit a control signal to the execution command generating unit 123 of the execution setting unit 120 to generate the execution command with reference to the automatic execution content stored in the execution storing unit 122.

The vehicle function controller 200 may be configured to operate a vehicle, a peripheral device of the vehicle, and an apparatus or a terminal including external communication units and may be disposed within the vehicle. However, the vehicle function controller 200 is not limited to being disposed within the vehicle, but may also be disposed within a general moving object, for example, a motorcycle, or the like. The vehicle function controller 200 may be configured to receive the execution command from the output I/F 170 of the control device 100 and execute an operation that corresponds to the execution command.

In the exemplary embodiment of the present invention, the condition storing unit 112 and the execution storing unit 122 may include a floppy disk drive (FDD), a hard disk drive (HDD), an optical disk drive (ODD), a tape device, a flash memory device, a computer readable medium, devices disposed in a storage network, or an array thereof. In addition, in the control device 100 according to the exemplary embodiment of the present invention, components such as the input I/F 160, the output I/F 170, and the information receiving unit 130 may be connected to an external device via various wired and wireless communication units including a wired communication unit such as an Ethernet, a universal serial bus (USB), a coaxial cable, a peripheral component interconnect (PCI) socket, or the like, and a wireless communication unit such as a Bluetooth, a radio frequency identification (RFID), a wireless Ethernet, other data network, or the like.

The control device 100 according to the exemplary embodiment of the present invention may be a hardware device or may be included in another device or terminal. In addition, a conceptual device and computer program performing the same function should be considered to be included in the scope of the present invention.

### Exemplary Embodiment 1

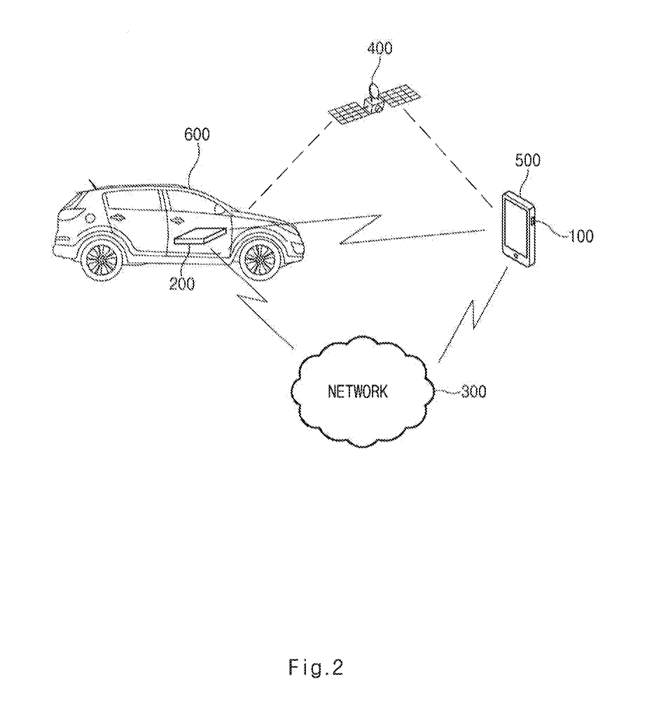

Hereinafter, Exemplary Embodiment 1 of the control device 100 will be described in detail with reference to FIGS. 2 to 6. In addition, the present invention is not limited by Exemplary Embodiment 1.

FIG. 2 is an exemplary schematic view of the control device 100 mounted within a mobile communication terminal 500 and a vehicle function controller 200 mounted within a vehicle 600. A user may use the control device 100 mounted within the mobile communication terminal 500 to transmit the execution command for the vehicle function controller 200.

The control device 100 may be configured to receive the setting for the condition and the execution by a method to be described below from the user via an input device such as a touch panel, or the like, included within the mobile communication terminal 500. The control device 100 may be configured to receive information from the above-mentioned various sensors (not shown) included within the mobile communication terminal 500, receive position information from a satellite 400 via a GPS, and receive information from a network 300. In addition, the control device 100 may be configured to receive information from devices included within the vehicle 600, for example, various sensors, modules, and the like. The control device 100 may be configured to determine whether the abovementioned information and the condition set in the control device 100 correspond. When the above-mentioned information and the condition correspond, the control device 100 may be configured to transmit the execution command to the vehicle function controller 200 via the output I/F 170 or a communication module (not shown) included within the mobile communication terminal 500.

In particular, the mobile communication terminal 500 may be a multi-functional portable phone terminal that uses 3G/4G data networks, called a smart phone, a portable phone terminal that uses 2G/3G data networks, called a feature phone, a personal digital assistant (PDA), a portable multimedia player (PMP), a tablet personal computer (PC), a laptop PC, or a notebook PC. In addition, the information may be transmitted using a wired electrical connection or may be wirelessly transmitted using a wireless data carrier, or the like, via WiFi, 3G/4G data networks, a near field communication network, or the like. Meanwhile, the network 300 may be used as the widest meaning such as a public API, cloud data, or the like, as well as the Internet.

Example of Setting Condition and Execution Content

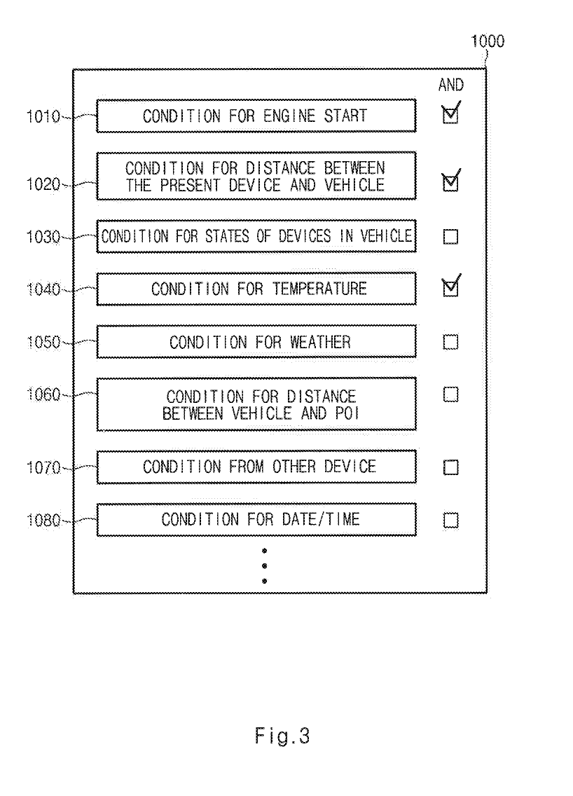

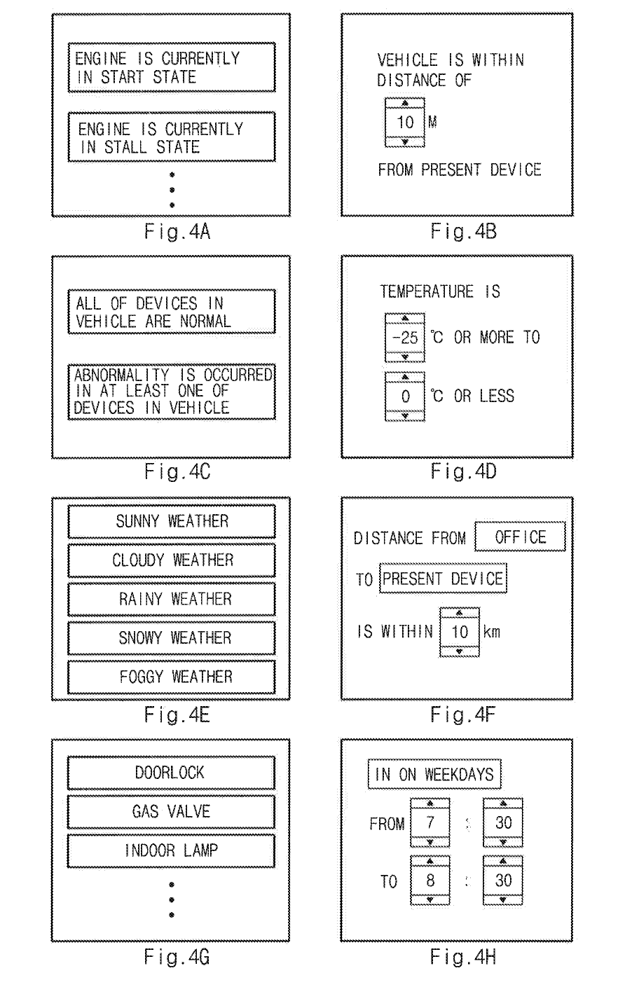

FIGS. 3 to 6 show an exemplary screen that may be displayed on the display unit 140 of the control device 100 (or a display of the mobile communication terminal 500) when the condition and the execution content are set in the control device 100 according to Exemplary Embodiment 1 of the present invention. A process of setting conditions of automatic execution in the condition setting unit 110 will be described below with reference to FIGS. 3 to 4H showing a screen displayed on the display unit 140.

FIG. 3 shows an exemplary a screen displayed on the display unit 140 in which conditions are set in the condition setting unit 110 of the control device 100 and are stored in the condition storing unit 112. On this screen 1000, the respective conditions 1010 to 1080 may be categorized into a plurality of categories for user convenience in setting the conditions. On the screen 1000 of FIG. 3, a condition 1010 for an engine start, a condition 1020 for a distance between the present device and the vehicle, a condition 1030 for states of devices within the vehicle, a condition 1040 for a temperature, a condition 1050 for a weather, a condition 1060 for a distance between the vehicle and a point of interest (POI), a condition 1070 from other device, and a condition 1080 for a date/time may be categorized and illustrated.

Each of these categories of the condition may be provided with a check box that may be selected by the user as shown at the right of the screen 1000. When the check boxes are marked, an intersection or an AND condition may be formed between the marked categories of the conditions, and the user marks the check boxes, and thus adjusting the condition. In FIG. 3, an example in which the check boxes that correspond to the categories of the condition 1010 for an engine start, the condition 1020 for a distance between the present device and the vehicle, and the condition 1040 for a temperature are marked is shown. These conditions may be connected as an AND condition and may become an automatic execution condition corresponding thereto.

The number of categories of the respective conditions shown to be eight 1010 to 1080 by way of example in FIG. 3 may be decreased or increased. In this way, the user may mix the categories which result in a large number of conditions. Using the check boxes of the AND condition described above, the condition of the automatic execution content may be set based on user intention. When the user selects the categories of the respective conditions 1010 to 1080 of FIG. 3 by touching a touch screen (or performing a click using a pointer, applying pressure to a screen, etc.), a screen may be switched for setting details of the conditions as shown in FIGS. 4A to 4H.

FIG. 4A shows an exemplary screen that represents details of the condition 1010 for an engine start. In FIG. 4A, ‘Engine is currently in start state’ and ‘Engine is currently in stall state’ are illustrated. The condition for an engine start may include other details in addition to the above-mentioned details. FIG. 4B shows a screen that represents details of the condition 1020 for a distance between the present device (e.g., the control device 100) and the vehicle 600. In FIG. 4B, ‘Vehicle is within distance of 10 m from present device’ is illustrated. In particular, ‘10 m’ that corresponds to the distance may be adjusted by the user.

FIG. 4C shows an exemplary screen that represents details of the condition 1030 for states of devices in the vehicle. In FIG. 4C, ‘All of devices in vehicle are normal’ and ‘Abnormality is occurred in at least one of devices in vehicle’ are illustrated. In particular, the device in the vehicle may include a device that may be diagnosed by a vehicle on-board diagnostics (OBD). In the details of the condition 1030 for states of devices in the vehicle, conditions for states of the respective devices within the vehicle may be provided as separate items unlike FIG. 4C. Therefore, when items of the respective devices in the vehicle are selected, a screen may be switched to setting details of a subordinate condition.

FIG. 4D shows an exemplary screen that represents details of the condition 1040 for a temperature. In FIG. 4D, ‘Temperature is −25° C. or more to 0° C. or less’ is illustrated. In particular, ‘−25° C.’ and ‘0° C.’ that each correspond to an upper limit and a lower limit of the temperature may be adjusted by the user. Additionally, the temperature may include a temperature obtained from the network or a temperature obtained from a temperature sensor that measures interior and exterior temperatures. These temperatures may be selected by the user.

FIG. 4E shows an exemplary screen that represents details of the condition 1050 for a weather. In FIG. 4E, ‘sunny weather’, ‘cloudy weather’, ‘rainy weather’, ‘snowy weather’, and ‘foggy weather’ are illustrated. A settable condition for the weather may be further sub-divided based on an amount of cloud or an amount of rainfall and may include other weather condition such as ‘yellow dust’, or the like. In addition, FIG. 4F shows an exemplary screen that represents details of the condition 1060 for a distance between the vehicle and a point of interest (POI). In FIG. 4F, ‘Distance from office up to present device is within 10 Km’ is illustrated. In particular, the ‘office’, which is a POI, may be set differently as a coordinate on a map, the ‘present device’ may also be changed into a ‘vehicle’, or the like, including a GPS, and ‘10 km’ may also be adjusted by the user.

FIG. 4G shows an exemplary screen that represents details of the condition 1070 from other device. This condition may be a precondition for generation of an execution command to operate other devices. In FIG. 4G, ‘doorlock’, ‘gas valve’, and ‘indoor lamp’ are illustrated. In addition to the above-mentioned examples, devices including other communication units may also be included. Although not shown, the user may apply pressure on the screen to each item (e.g., or clicks each item using a pointer) to select the item, to set details of the condition of the selected item. For example, when an item ‘indoor lamp’ is selected, a condition such as ‘Indoor lamp is turned on’, ‘Indoor lamp is turned off’, or the like, may be set. This corresponds to execution for operation of other devices to be described below and may be a part of home automation (HA) and a car to infrastructure (C2I).

FIG. 4H shows an exemplary screen that represents details of the condition 1080 for a date and time. This condition may be a temporal condition of the automatic execution content and may be configured to be adjustable by the user. In FIG. 4H, ‘from 7:30 to 8:30 in on weekdays’ is illustrated. In particular, in a date, a day of the week, a workday/holiday, or the like, may be set, and a time may be separately set. Therefore, the user may be provided for the execution for the function of the vehicle at a more appropriate time.

The categories of the conditions 1010 to 1080 are merely examples. Therefore, other categories may be added to the categories or some of the categories may be excluded and details of subordinate items and subordinate conditions may also be changed as described above.

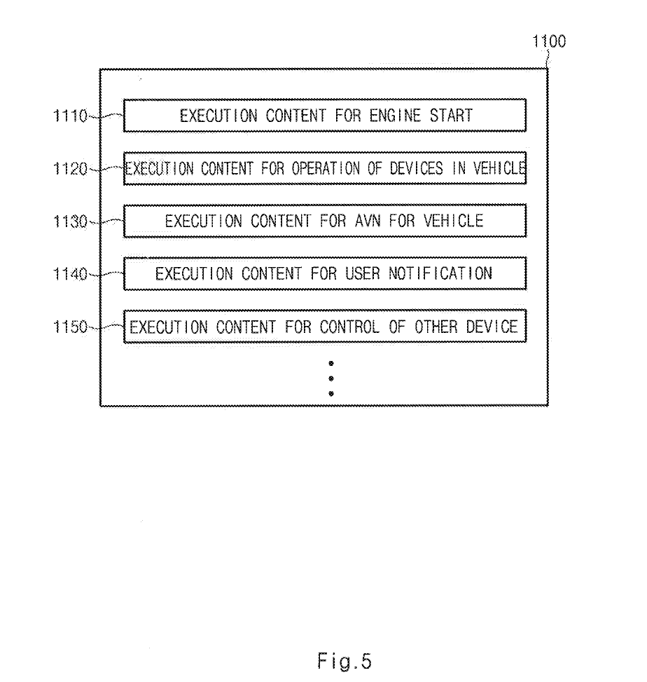

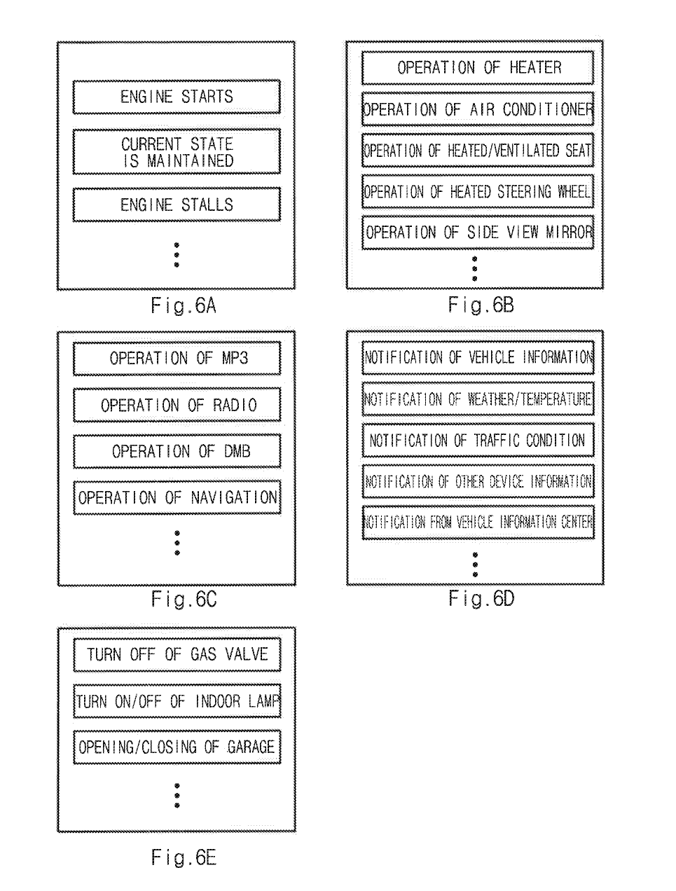

Furthermore, a process of setting an automatic execution content that becomes a premise of transmission of an execution command to the vehicle function control device 200 will be described below with reference to FIGS. 5 to 6E showing a screen displayed on the display unit 140.

FIG. 5 shows an exemplary screen displayed on the display unit 140 in which automatic execution contents may be set by the execution setting unit 120 of the control device 100 and may be stored in the execution storing unit 122. On this screen 1100, the respective automatic execution contents 1110 to 1150 may be categorized into a plurality of categories for user convenience in setting the automatic execution contents. On the screen of FIG. 5, an execution content 1110 for an engine start, an execution content 1120 for an operation of devices within the vehicle, an execution content 1130 for audio, video, and navigation (AVN) for the vehicle, an execution content 1140 for user notification, and an execution content 1150 for operation of other devices may be categorized and illustrated. The number of categories of the automatic execution contents shown to be five 1110 to 1150 by way of example in FIG. 5 may be decreased or increased.

When the user selects the categories of the respective automatic execution contents 1110 to 1150 of FIG. 5 by touching a touch screen (or performing a click using a pointer), a screen may be switched for setting details of the automatic execution contents as shown in FIGS. 6A to 6E. However, although the screen of FIG. 5 may be configured to set a single execution content in setting the automatic execution contents to prevent user confusion, each category of the automatic execution contents 1110 to 1115 of the screen may also include check boxes that form an AND condition to perform a plurality of automatic execution contents under the same condition, similar to the case of FIG. 3.

FIG. 6A shows an exemplary screen that represents details of the execution content 1110 for an engine start. In FIG. 6A, ‘Engine starts’, ‘Current state is maintained’, and ‘Engine stalls’ are illustrated. The execution content for an engine start may include different contents such as ‘Engine is currently in stall state, but will start after five minutes, ‘Engine is currently in start state, but will stall after five minutes’, and the like. Meanwhile, the execution content for an engine start may not be set for an execution content under a specific condition, that is, it may be directly associated with safety of a driver (user).

FIG. 6B shows an exemplary screen that represents details of the execution content 1120 for an operation of devices within the vehicle. In FIG. 6B, ‘operation of heater’, ‘operation of air conditioner’, ‘operation of heated/ventilated seat’, ‘operation of heated steering wheel’, and ‘operation of side view mirror’ are illustrated. Each item for operations of the devices within the vehicle may include execution contents for each device within the vehicle. Although not shown, when the user selects each item for the operations of the devices within the vehicle by touching a touch screen (or performing a click using a touch pointer), a screen may switch to representing subordinate details for the operation of the device within the vehicle for the selected item. For example, when the item ‘operation of air conditioner’ is selected, a screen may be switched to adjusting whether the air conditioner is operated, operation strength of the air conditioner, or the like. Likewise, the number of devices within the vehicle shown to be five by way of example in FIG. 5 may be increased or decreased.

FIG. 6C shows an exemplary screen that represents details of the execution content 1130 for AVN for the vehicle. In FIG. 6C, ‘operation of MP3’, ‘operation of radio’, ‘operation of DMB’, and ‘operation of navigation’ are illustrated. The number of devices or functions of the AVN for the vehicle may be decreased or increased by way of example. Meanwhile, the ‘operation of MP3’ may include a streaming service via a netword and reproduction of a music file pre-stored in the vehicle terminal or the mobile communication terminal, and the ‘operation of navigation’ may include execution of an application (or program) that provides a navigation function of the mobile communication terminal and navigation pre-installed in the vehicle. Likewise, although not shown, when the item shown in FIG. 6C is selected, a screen may switch to representing subordinate details for the operation of the device within the vehicle for the selected item. For example, when the item ‘operation of MP3’ is selected, the screen may switch to selecting a music file. In addition, the execution content for AVN for the vehicle may not be set for an execution content under a specific condition for safety of a driver (user).

FIG. 6D shows an exemplary screen that represents details of the execution content 1140 for user notification. In FIG. 6D, ‘notification of vehicle information’, ‘notification of weather/temperature’, ‘notification of traffic condition’, ‘notification of other device information’, and ‘notification firm vehicle information center’ are illustrated. The execution content 1140 for user notification may be an execution content for notifying information received via the information receiving unit 130 to the user when a preset condition is satisfied. This may be to notify the general information regarding the vehicle to the user to allow the user to recognize the general information, provide useful information to the user, or warm the user of a specific danger.

In particular, the vehicle information may be an item that may be diagnosed by the vehicle OBD, such as fuel, engine oil, or the like, other device information may be information received from other devices, and the notification from the vehicle information center may be notification of information provided from a server managed by a manufacturer of the vehicle, or the like, to the user. This notification may be an execution command to the vehicle function controller 200. However, the vehicle function controller 200 that receives the execution command may use a method of notifying the execution command in a speech form (e.g., verbal output) via the terminal within the vehicle or the mobile communication terminal using a text to speech (ITS) program, displaying the execution command on a screen of the terminal within the vehicle or the mobile communication terminal, notifying the execution command using a vibrator of the terminal within the vehicle or the mobile communication terminal, and the like, as a control method. Two or more notifying methods rather than one notifying method may be performed simultaneously. In addition, there may be a notifying method other than the above-mentioned notifying methods. Meanwhile, the execution command may be provided from the control device 100 to the mobile communication terminal via the vehicle function controller 200 or be provided directly from the control device 100 to the mobile communication terminal.

FIG. 6E shows an exemplary screen that represents details of the execution content 1150 for operation of other devices. In FIG. 6E, ‘turn off of gas valve’, ‘turn on/off of indoor lamp of house’, and ‘opening or closing of garage’ are illustrated. The execution content 1150 for operation of other devices may be an execution content to transmit the execution command from the control device 100 according to the exemplary embodiment of the present invention to other devices, e.g., a device attached to a building, via the vehicle function controller 200 using the network 300. This execution may be a part of the HA and C2I as described above. Likewise, although not shown, when the item shown in FIG. 6E is selected, a screen may switch to representing subordinate details for operation of other devices for the selected item. For example, when the item ‘turn on/off of indoor lamp of house’ is selected, the screen may switch to selecting an indoor lamp on which a turn-on/off operation may be performed. Examples of execution contents for operation of other devices may be various in addition to the above-mentioned examples, and the device receiving the execution command needs not to be necessarily attached to the building.

Since some of the automatic execution contents may be directly associated with safety of the driver (user) in that they are execution contents for the vehicle, specific execution contents may not be set by the user.

### Exemplary Embodiment 2

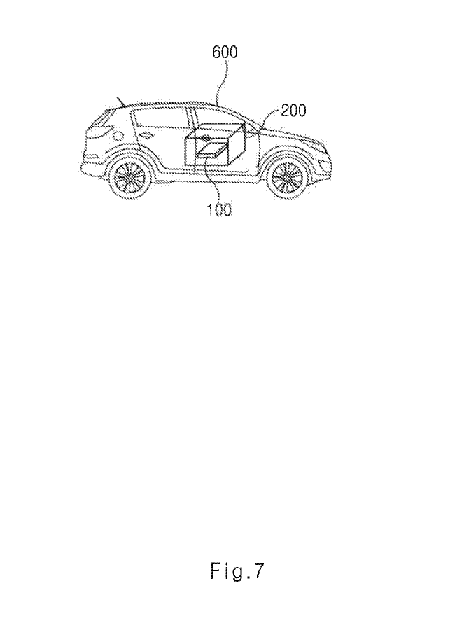

Hereinafter, Exemplary Embodiment 2 of the control device 100 will be described in detail with reference to FIG. 7. FIG. 7 is a schematic view of the case in which the control device 100 according to Exemplary Embodiment 2 of the present invention is mounted in a vehicle function controller 200 of a vehicle 600. The user uses the control device 100 mounted in the vehicle function controller 200 to transmit an execution command for the vehicle function controller 200 and accomplish predetermined objectives.

The control device 100 receives the setting for the condition and the execution content by the same method as of Exemplary Embodiment 1 from the user through an input device such as a touch panel included in the control device 100 itself the vehicle 600, or the vehicle function controller 200. The control device 100 judges whether the position information received from the satellite 400 through the GPS module, the information received from the network 300, and information received from sensors and modules included in the vehicle 600 coincide with the set condition. In the case in which the above-mentioned information does not coincide with the condition, the control device 100 transmits the execution command to the vehicle function controller 200 through an internal wired wiring (not shown) or a communication module (not shown) included in the vehicle function controller 200.

The control device 100 according to Exemplary Embodiment 2 may be implemented as a part of a device in the vehicle function controller 200 or be implemented as an intangible device (a program to be installed) in the vehicle function controller 200.

Since the configuration and the setting for conditions and execution contents of the control device according to Exemplary Embodiment 2 are the same as those of the control device according to Exemplary Embodiment 1, a description thereof will be omitted.

Example of Control Method of Control Device 100

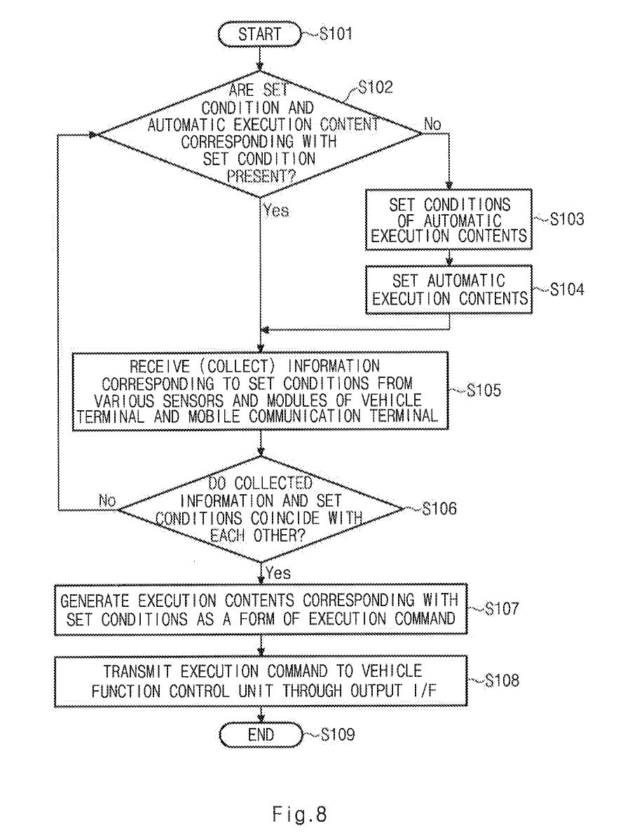

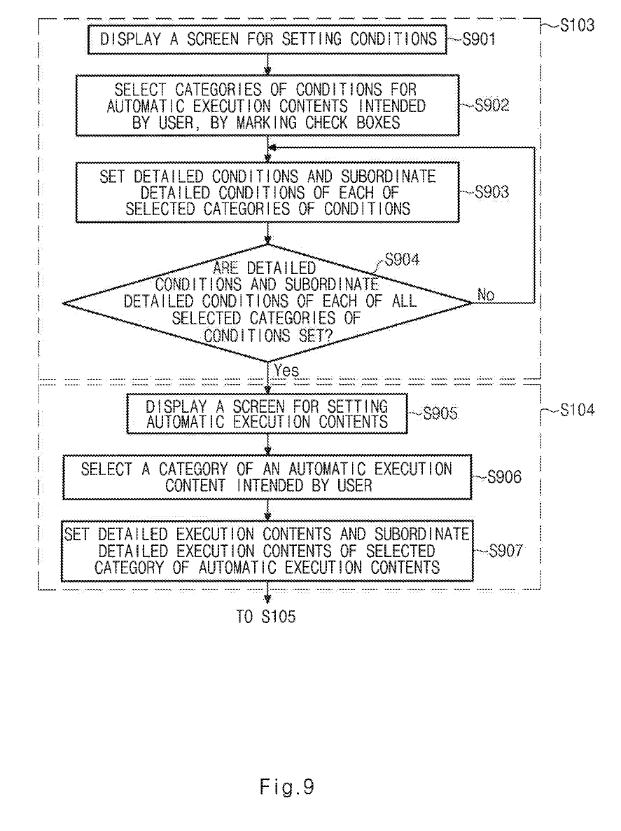

Hereinafter, a control method of the control device 100 that may communicate with the vehicle function controller 200 to execute functions associated with the vehicle and request the vehicle function controller 200 to execute the functions will be described in detail with reference to flow charts of FIGS. 8 and 9. FIG. 8 is an exemplary flow chart of the operating process of the control device according to the exemplary embodiment of the present invention; and FIG. 9 is an exemplary flow chart for details of S103 and S104.

When the control device 100 is operated (S101), the controller 150 of the control device 100 may be configured to determine whether a set condition exists in the condition storing unit 112 of the condition setting unit 110 and an automatic execution content that corresponds to the set condition exists in the execution storing unit 122, in S102. When the set condition and the automatic execution content that correspond to the set condition are present, the control method may proceed to S105. Otherwise, the process may proceed to S103.

In S103 a condition for executing a function may be automatically executed among the functions associated with the vehicle may be set, the control device 100 may be configured to receive an input for the condition from an input device such as an external touch pad or pointer, a microphone, or the like, via the input I/F 160. The received input may be stored in the condition storing unit 112 as a condition for generation of the execution command via the input receiving unit 111 of the condition setting unit 110. Then, in S104 a content to be automatically executed may be set when the set condition is satisfied, the control device 100 may be configured to receive an input for the automatic execution content from the input device such as the external touch pad or pointer, the microphone, or the like, via the input I/F 160, similar to S103. The received input may be stored in the execution storing unit 122 as an automatic execution content for generation of the execution command via the input receiving unit 121 of the execution setting unit 120.

When the condition and the automatic execution content to the condition are set (e.g., in the case of Yes in S102) or after S103 and S104, the control method may proceed to S105. In S105, the controller 150 may be configured to receive information from the above-mentioned various sensors, modules, and the like, via the information receiving unit 130. The information may be information recognized by sensors and recognizing devices, including various sensors of the vehicle, such as the temperature sensor, the illuminance sensor, the lane departure preventing sensor, the front and rear imaging devices (e.g., cameras), the fuel sensing sensor, the communication module, the GPS (sensor), etc., a vehicle controller, and the like, or be information recognized by sensors and modules disposed in the mobile communication terminal, such as the gyroscope sensor, the geomagnetic sensor, the acceleration sensor, the optical (illuminance) sensor, the proximity sensor, the digital compass, the GPS, the near field communication module, the temperature sensor, and the like, as described above.

Further, the information may also include information, or the like, obtained from a terminal within the vehicle or a mobile communication terminal from the Internet or the network that may be connected to the public API, or the like. In other words, in S105, the information may be received from the vehicle 600, the control device 100, or the network 300 and may be provided to the condition setting unit 110.

In S106, the controller 150 may be configured to reference the information obtained in S105 and the condition set in S103 and stored in the condition storing unit 112 of the condition setting unit 110 and match the conditions. As the matching result, when the set condition is satisfied (e.g., the information and the set condition correspond, in the case of Yes in S106), the control method may proceed S107. Otherwise, the control method may return to S102, such that processes after S102 may be performed.

In S107, when the received information and the set condition correspond in S106 (e.g., in the case of Yes in S106), the controller 150 of the control device 100 may be configured to reference the execution storing unit 122, and the execution command generating unit 123 may be configured to generate the execution command for requesting to the vehicle function controller 200 for automatic execution based on the automatic execution content stored in the execution storing unit 122. Then, in S108, the execution command generated by the execution command generating unit 123 of the execution setting unit 120 may be transmitted, by the controller 150 (e.g., a first controller) to the vehicle function controller 200 via the output I/F 170 in a wired or wireless scheme. As a result, an operation of the control device 100 according to the exemplary embodiment of the present invention may be completed (S109).

Hereinafter, operations of S103 and S104 will be described in detail. In FIG. 9, S901 to S904 correspond to S103, and S905 to S907 correspond to S104.

In S901, the display unit 140 of the control device 100 may be configured to display a predetermined screen (e.g., the screen 1000 of FIG. 3) for setting conditions in the case of No in S102. As described above, the screen may include a plurality of categories for setting the conditions, wherein each category may have a check box for setting an AND condition. Then, in S902, the user may select categories to be conditions of automatic execution contents among the categories of the conditions already categorized on the screen by marking the AND check box provided at each category.

Further, in S903, the user may set detailed conditions (or subordinate items) and subordinate detailed conditions of each of the selected categories of the conditions. Then, the control process may proceed to S904. In S904, the controller 150 of the control device 100 may be configured to determine whether each of detailed conditions (or subordinate items) and subordinate detailed conditions of all categories selected by the user, are set. When each detailed conditions, and the like, of all of the categories are set, the control process may proceed to S104 (Yes in S904). Otherwise, the control process may return S903 (No in S904).

Furthermore, in S905, the display unit 140 of the control device 100 may be configured to display a predetermined screen (e.g., the screen 1100 of FIG. 5) for setting automatic execution contents. In particular, categories of the automatic execution contents may have the check box for selecting a plurality of categories as in the screen of S901. However, to prevent user confusion, in the present flow chart, a single automatic execution content is set without the check box. In S906, the user may select categories of automatic execution contents among the categories of the automatic execution contents already categorized on the screen. Then, in S907, the user may set detailed execution contents (or subordinate items) and subordinate detailed execution contents of the selected categories of the automatic execution contents. Then, the control process may proceed to S105 of FIG. 8.

### Specific Exemplary Embodiment

Hereinafter, a specific exemplary embodiment of the control device 100 according to an exemplary embodiment of the present invention will be described. The following specific exemplary embodiment is based on Exemplary embodiment 1 in which the control device 100 is mounted within the mobile communication terminal 500.

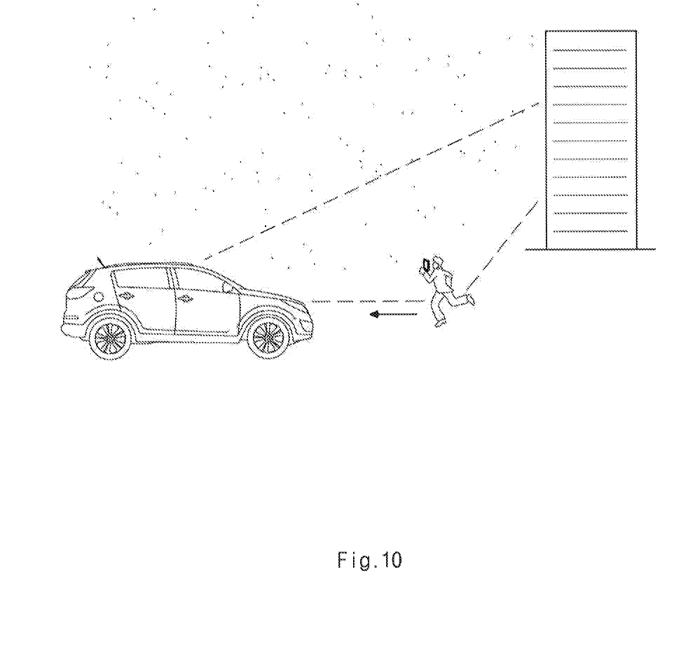

FIG. 10 shows the user that corresponds to a householder of a single household approaching the vehicle to go to the office in a state in which a gas valve is opened on a snowy day. Meanwhile, it may be assumed that the user has previously set conditions and automatic execution contents as represented by the following Table 1.

TABLE 1

| Serial | | Automatic execution |
|---|---|---|
| No. | Condition | content |
| 1 | Engine is currently in stall state | Engine starts |
| | AND Vehicle is within 5 m from the | |
| | present device | |
| | AND From 7:30 to 8:30 in on | |
| | weekdays | |
| 2 | Engine is currently in stall state | Weather/temperature |
| | AND Vehicle is within 5 m from the | notification |
| | present device | (notification |
| | AND From 7:30 to 8:30 in on | through speech) |
| | weekdays | |
| 3 | Engine is currently in stall state | Notification from |
| | AND Vehicle is within 5 m from the | vehicle information |
| | present device | center (notification |
| | AND snow (weather) | through screen) |
| 4 | Engine is currently in start state | Operation of Heater |
| | AND Vehicle is within 5 m from the | |
| | present device | |
| | AND Temperature is −35° C. or | |
| | greater to 10° C. or less | |
| 5 | Engine is currently in start state | Turn off of gas |
| | AND Vehicle is within 5 m from the | valve |
| | present device | |
| | AND Turned on gas valve | |
| | AND From 7:30 to 8:30 in on | |
| | weekdays | |

According to the above Table 1, in each of Serial No. 1 to 5, one or more execution condition is suggested. The respective execution conditions mean that execution that corresponds to the execution conditions may be performed when the conditions connected to each other in an AND condition are satisfied. In particular, in each of the serial numbers, the presented conditions may be conditions of which the check boxes of the categories have been marked on the screen 1000 of FIG. 3.

The automatic execution content may be transmitted in an execution command form to the vehicle function control device 200, and the vehicle function control device 200 may be configured to execute an operate that corresponds to the automatic execution content on each device of the vehicle or other external device. More specifically, in the case of Serial No. 1, ‘Engine is currently in stall state’ AND ‘Vehicle is within 5 m from the present device’ AND ‘From 7:30 to 8:30 in on weekdays’ are set as conditions, and ‘Engine starts’ is set as an automatic execution content. Therefore, the user may automatically start the engine that is in the stall state by bringing the terminal having the control device 100 into 5 m from the vehicle. In addition, since the conditions for the weather/time are set, a phenomenon that the engine erroneously starts when the user approaches the vehicle in the weekend or a time except for a time from 7:30 to 8:30 may be prevented.

In the case of Serial No. 2, ‘Engine is currently in stall state’ AND ‘Vehicle is within 5 m from the present device’ AND ‘From 7:30 to 8:30 in on weekdays’ are set as conditions, and ‘Weather/temperature notification (notification through speech)’ is set as an automatic execution content. Likewise, the user may obtain weather information, which may be information useful for driving the vehicle, by bringing the terminal having the control device 100 into 5 m from the vehicle in a time from 7:30 to 8:30. In particular, information such as a temperature of ‘−10° C.’ and ‘snowy’ weather may be provided. The temperature may be measured by the temperature sensor disposed within the vehicle, and information regarding the weather and the temperature may be obtained from the network via the terminal within the vehicle or the mobile communication terminal.

In the case of Serial No. 3, ‘Engine is currently in stall state’ AND ‘Vehicle is within 5 m from the present device’ AND ‘snow (weather)’ are set as conditions, and ‘Notification from vehicle information center (notification through screen)’ is set as an automatic execution content. Information provided from the vehicle information center may be information such as matters to be marked on a snowy day, that is, whether or not an antifreezing solution freezes, whether or not a snow chain is attached, or the like, and may include information provided from a manufacturer of the vehicle, or the like, for vehicle maintenance, and traffic information. The information may be produced by, for example, the manufacturer of the vehicle, or the like, and the user may obtain the information from the network 300 via the display of the terminal within the vehicle or the mobile communication terminal 500. Thus, the user may receive vehicle related information appropriate for weather to promote safe driving, and the manufacturer of the vehicle, or the like, may provide useful information to the user. In addition, the manufacturer of the vehicle, or the like, may allow an advertisement, or the like, to be included in this service, thereby making it possible to commercially utilize the present control device 100.

In the case of Serial No. 4, ‘Engine is currently in start state’ AND ‘Vehicle is within 5 m from the present device’ AND ‘Temperature is −35° C. or more to 10° C. or less’ are set as conditions, and ‘Operation of Heater’ is set as an automatic execution content. The temperature may not be obtained from the network via the terminal within the vehicle or the mobile communication terminal 500, but may be obtained by the temperature sensor disposed within the vehicle 600. Therefore, the user may receive an interior temperature of the vehicle prior to entering the vehicle 600 (e.g., the user may heat the vehicle before entering the vehicle).

In the case of Serial No. 5, ‘Engine is currently in start state’ AND ‘Vehicle is within 5 m from the present device’ AND ‘Turned on gas valve’ AND ‘From 7:30 to 8:30 in on weekdays’ are set as conditions, and ‘Turn off of gas valve’ is set as an automatic execution content. The present condition and execution, which are examples of C2I, may correspond to operating an external device, including a device having communication measure in a building, using a communication module associated with the vehicle function control device 200. Therefore, the user may turn off for example, the gas valve before entering the vehicle after leaving a house, thus promoting safety.

### Modified Example

In examples of setting the conditions and the automatic execution contents as described above, the automatic execution contents were set after the conditions are set. However, unlike this, the automatic execution contents may also be set before the conditions are set. Therefore, a top down setting method of setting automatic execution contents and then setting conditions that correspond with the automatic execution contents may also be possible. In other words, in FIG. 8, S104 (S905 to 5907 of FIG. 9) may also be performed before S103 (S901 to S904 of FIG. 9). Since the user may consider the automatic execution contents in using the control device 100 according to the exemplary embodiment of the present invention, S104 may be performed before the S103 to improve convenience of the user.

In addition, in the control device 100 that may communicate with the vehicle function controller to execute the functions associated with the vehicle and request the vehicle function controller 200 to execute the functions, the set conditions (including subordinate items and subordinate detailed conditions) and the automatic execution contents that correspond with the set conditions may be changed after being set. Therefore, for example, when the execution content and the condition for the operation of the heater are set, the condition and the category of the automatic execution content for the operation of the heater and details corresponding thereto may be changed. Thus, the user may change a preset condition and execution content to prevent the heater from being operated in warmer weather, such as during the summer. Further, conditions and execution contents that may be most frequently used statistically by the user may be suggested to the user by applying a recent big data technology.

According to the exemplary embodiment of the present invention, the functions of the vehicle, or the like, may be automatically executed based on the conditions depending on the demands of the users that may be different, thereby making it possible to optimize the functions of the vehicle, or the like, for each of the individual users. In addition, since information used to determine conditions for automatic execution may be obtained from the vehicle, the terminal, and the network, the condition determination and execution for the functions of the vehicle may be provided in further accordance with user's actual intention.

Further, the functions of the vehicle and peripheral devices of the vehicle may also include a control of other device, to more appropriately cope with home automation (HA) connected to the vehicle and the network. Therefore, the control device according to the exemplary embodiment of the present invention may operate as a platform executing various functions associated with the vehicle in automatically controlling the vehicle, or the like.

What is claimed is:

1. A control device that communicates with a vehicle function controller to execute functions associated with a vehicle, comprising:
a memory configured to store program instructions; and
a processor configured to execute the program instructions, the program instructions when executed configured to:
set conditions to execute functions to be automatically executed among the functions associated with the vehicle based on user intention; and
set the functions to be automatically executed based on the user intention when the set conditions are satisfied.

2. The control device according to claim 1, wherein the program instructions when executed are further configured to:
categorize the functions to be automatically executed into a plurality of categories.

3. The control device according to claim 1, wherein the program instructions when executed are further configured to:
receive information from the vehicle, information from the control device, or information from a network.

4. The control device according to claim 3, wherein the received information is categorized into a plurality of categories.

5. The control device according to claim 1, wherein the functions to be automatically executed operate at least one of the vehicle, a device within the vehicle, and a device connected to a network.

6. The control device according to claim 1, wherein the set conditions or the functions to be automatically executed are changeable after being set.

7. The control device according to claim 1, wherein the control device is disposed within the vehicle function controller.

8. The control device according to claim 1, wherein the control device is disposed within a portable terminal.

9. A control method of a control device that communicates with a vehicle function controller to execute functions associated with a vehicle, comprising:
setting by the function vehicle controller, conditions for executing functions to be automatically executed among the functions associated with the vehicle; and
setting, by the function vehicle controller, the functions to be automatically executed when the set conditions are satisfied.

10. The control method according to claim 9, wherein the setting of the functions to be automatically executed is performed before the setting of the conditions.

11. The control method according to claim 9, further comprising:
receiving, by the vehicle function controller, information from the vehicle, information from the control device, or information from a network.

12. The control method according to claim 9, father comprising:
executing, by the vehicle function controller, the functions to be automatically executed when the set conditions are satisfied.

13. A non-transitory computer readable medium that communicates with a vehicle function controller to execute functions associated with a vehicle, comprising:
program instructions that set conditions to execute functions to be automatically executed among the functions associated with the vehicle based on user intention; and
program instructions that set the functions to be automatically executed based on the user intention when the set conditions are satisfied.

14. The non-transitory computer readable medium of claim 13, further comprising:
program instructions that categorize the functions to be automatically executed into a plurality of categories.

15. The non-transitory computer readable medium of claim 13, further comprising:
program instructions that receive information from the vehicle, information from the control device, or information from a network.

16. The non-transitory computer readable medium of claim 15, wherein the received information is categorized into a plurality of categories.

17. The non-transitory computer readable medium of claim 13, wherein the functions to be automatically executed operate at least one of the vehicle, a device within the vehicle, and a device connected to a network.

18. The non-transitory computer readable medium of claim 13, wherein the set conditions or the functions to be automatically executed are changeable after being set.

19. The non-transitory computer readable medium of claim 13, wherein the control device is disposed within the vehicle function controller.

20. The non-transitory computer readable medium of claim 13, wherein the control device is disposed within a portable terminal.
